(19) United States
(12) Patent Application Publication
(10) Pub. No.: US 2015/0114809 A1
(43) Pub. Date: Apr. 30, 2015

(54) ELECTROMECHANICAL LOW VOLTAGE SWITCH

(71) Applicant: Doduco GmbH, Pforzheim (DE)

(72) Inventor: Dirk Moog, Remchingen (DE)

(21) Appl. No.: 14/588,551

(22) Filed: Jan. 2, 2015

Related U.S. Application Data
(63) Continuation of application No. PCT/EP2013/063427, filed on Jun. 26, 2013.

(30) Foreign Application Priority Data
Jul. 5, 2012 (DE) 10 2012 106 053.3

(51) Int. Cl. H01H 1/50

(52) U.S. Cl. CPC H01H 1/50
USPC 200/301

(57) ABSTRACT

An electromechanical low voltage switch has a movable switching element that has an electrically conductive support and at least one electrical contact piece attached to this support. The support consists, at least in part, of a metal or of an alloy, the density of which lies below 5 g/cm³.

### CROSS-REFERENCE TO RELATED APPLICATIONS

This continuation application claims priority to PCT/EP2013/063427 filed on Jun. 26, 2013 which has published as WO 2014/005908 A1 and also the German application No. 10 2012 106 053.3, filed Jul. 5, 2012, the contents of which are fully incorporated herein with these references.

### DESCRIPTION

1. Field of the Invention

The invention relates to an electromechanical low voltage switch in accordance with the preamble of independent claim, having a movable switching element that has an electrically conductive support and at least one electrical contact piece attached to this support.

2. Background of the Invention

On closing the switch the movable contact piece impacts a fixed contact. In this connection, bouncing of the two contacts can occur. Bouncing is a mechanically triggered interference effect. For a short time, in the millisecond range, multiple closing and opening of the switch occurs. More rarely, bouncing can also occur when the switch is opened. Bouncing is caused by spring reactions at components of the switch mechanism. If above the arc voltage the switch opens briefly again as the result of bouncing, then an arc burns between the fixed contact and the movable contact of the switch. At the foot of the arc, local melting of the contact surface occurs, possibly leading to splashing of the contact material, thereby causing the contact to lose mass. This loss of contact material is also referred to as burn-off. Burn-off shortens the useful lifetime of the switch. Furthermore, the splashed contact material can accumulate on other surfaces of the switch and cause problems.

It is an object of the present invention to reduce the burn-off of the contacts of the electromechanical switch that is caused by switching operations.

This object is accomplished by means of an electromechanical switch having the characteristics indicated in the independent claim. Advantageous further developments of the invention are included in the dependent claims. A switching element for use in an electromechanical low voltage switch is claimed in another independent claim.

### SUMMARY OF THE INVENTION

The electromechanical low voltage switch according to the invention has a movable switching element that has an electrically conductive support and at least one electrical contact piece attached to this support. The support consists, at least in part, of a metal or of an alloy having a density below 5 g/cm³.

This has significant advantages:

1) Compared to a support composed of copper, which is usual in the state of the art, a support according to the invention, having the same dimensions as in the state of the art, has a lower mass than a support composed of copper. As a result, the tendency to bounce is reduced or entirely prevented. As a further consequence, the frequency of the occurrence of arcs decreases very significantly. The occurrence of fewer arcs leads to a longer useful lifetime of the low voltage switch.

2) The closing and opening movements that otherwise occur during bouncing and rapidly follow one another can generate interference signals that lead to problems in a downstream electrical or electronic circuit. Such problems can be avoided by means of the avoidance of bouncing events according to the invention. Filters and similar circuits for preventing or suppressing interference signals can become superfluous, according to the invention.

3) Copper has become expensive recently. Replacement of copper for the electrically conductive support with a lighter metal can save costs.

Preferably, the support consists of a light metal or of a light-metal alloy. Possible light metals are, in particular, aluminum, magnesium, and lithium, as well as their alloys. The light metals can be alloyed with other metals that have a density of 5 g/cm³ or more. Alloys of aluminum, magnesium, and lithium with one another are particularly preferred. They are characterized by their particularly low density and good electrical conductivity.

Preferably, the support is provided, at least in a partial region of the support that borders on the at least one contact piece, with a layer composed of an electrically well conductive material, which does not ignite in air under the effect of an arc. In this way, the risk that the light metal ignites under the effect of the arc, if the foot point of the arc were to move down from the contact piece attached to the support, can be prevented.

Well conductive metals such as copper, silver, iron, and alloys of these metals are particularly suitable as a material for the layer that does not ignite under the effect of an arc. Preferably, this layer is at least 0.1 mm thick. In the case of thinner layers, the risk that the arc penetrates the layer and ignites the light metal situated underneath it increases. It is practical if the layer is not thicker than 1 mm; a greater thickness leads to no significant improvement in the resistance capacity against the effect of an arc. Preferably, the thickness of the layer amounts to 0.4 mm to 0.6 mm.

Preferably, the support consists—with the exception of the layer of the material that does not ignite under the effect of an arc, which layer is provided on the support—in total of a light metal or of a light-metal alloy. This enables a particularly low mass of the support, thereby enabling a low or negligible tendency of the low voltage switch to bounce or making it easier to suppress bouncing. Compared to a conventional switch composed of copper, its mass can drop to less than half in this way, for example to ⅓ to ¼ of the mass of a conventional copper support having the same dimensions.

In order to enable the layer composed of the material that does not ignite under the effect of an arc to develop its desired effect, it must be provided on that side of the support to which the contact piece or—if two contact pieces are provided—the two contact pieces are attached. Such a layer does not need to be provided on the other sides of the support. Preferably, however, such a layer is also provided on that side of the support that faces away from the one contact piece or away from the multiple contact pieces of the support. This has the advantage that in the event of a change in the temperature of the support, different thermal expansion coefficients of the support material and of the material of the layer provided on the support do not lead to a curvature of the support.

It is practical if the layer composed of the material that does not ignite under the effect of an arc is provided on the entire surface of that side of the support to which the at least one contact piece is attached, and preferably also on the entire surface of that side of the support that faces away from the at least one contact piece. Then it is ensured, under all circumstances that the foot point of an arc, if it were to migrate down from one of the contact pieces, can, in any case, only migrate on the layer that consists of the material that does not ignite under the effect of an arc.

The electrically conductive support of the at least one contact piece frequently consists of a metal sheet and can be a part made by stamping or by stamping and bending. If a layer of the material that does not ignite under the effect of an arc is provided only on that side of the support on which the at least one contact piece is provided, which side will hereinafter be referred to as the front side of the support, and even if such a layer is provided on the back side of the support, which faces away from the at least one contact piece, but the support does not have a layer that does not ignite under the effect of an arc on all its surfaces, then corrosion, particularly contact erosion, can occur. In order to counter this, one could consider coating the support on all sides with the material that does not ignite under the effect of an arc. Coating of the support on all sides can take place by means of a wet-chemical coating process, namely in an electrolytic bath or in a bath that works with chemical reduction without externally applied current. In this manner, the support could be coated on all sides with a material that does not ignite under the effect of an arc, with electrolytic coating being preferred. However, it would be too elaborate to deposit the layer having a thickness of a few tenths of a millimeter, which is supposed to protect the support for the at least one electrical contact piece from the effect of an arc, entirely from an electrolytic bath or from a chemically reductive bath. For this reason, it is preferred to apply the layer that is supposed to withstand the effect of an arc to the front side of the support, and, if necessary, also to the back side of the support, facing away from the front side, in a thickness of several tenths of a millimeter, by means of roll cladding, and to protect the surfaces not covered by the roll-cladded layer, particularly the lateral cut surfaces of the support, in that a material that does not ignite under the effect of an arc is deposited by a wet-chemical process, particularly by electrodeposition. It is practical to use the same material as for the roll cladding, particularly copper, for this purpose, in a layer thickness of several μm. Preferably, such a protective layer is applied to the support on all sides, if necessary also to the layer that has already been applied by means of roll cladding, composed of the material that does not ignite under the effect of an arc. Only afterward the at least one contact piece is attached to the support, using a usual method, for example by means of welding, brazing, or riveting.

The invention is suitable for all types and shapes of supports that are usual in low voltage switches. In particular, the support can form a contact bridge, can be a contact spring or can be attached to the tip of a spring.

Not only a low voltage switch according to the independent claim, but also a switching element for a low voltage switch, which element makes the low voltage switch a low voltage switch according to the invention when used as intended, is an object of the present invention.

In an exemplary embodiment, an electromechanical low voltage switch has a movable switching element that has an electrically conductive support and at least one electrical contact piece attached to this support, wherein the support consists, at least in part, of a metal or of an alloy, the density of which lies below 5 g/cm³.

The support may consist of a light metal or of a light-metal alloy, wherein aluminum, magnesium, and lithium, as well as their alloys with one another and/or with other metals are particularly suitable as light metals.

At least in a partial region that borders on the at least one contact piece, the support may have a layer composed of a material that does not ignite in air under the effect of an arc. The material for the layer that does not ignite under the effect of an arc may consist of copper, silver, iron or an alloy of these metals. The layer may have a thickness of at least 0.1 mm. The layer may have a thickness of not more than 1 mm. The layer may have a thickness between 0.4 mm and 0.6 mm.

The support may consist—with the exception of the layer preferably provided on it—in total of a light metal or of a light-metal alloy.

The layer composed of the material that does not ignite under the effect of an arc may be provided at least on that side of the support on which the at least one contact piece is also provided. The layer composed of the material that does not ignite under the effect of an arc may be provided not only on that side of the support on which the at least one contact piece is attached, but also on the side of the support that faces away from the at least one contact piece. The material that does not ignite under the effect of an arc may also provided on the entire surface of the side of the support that faces away from the at least one contact piece. The layer composed of the material that does not ignite under the effect of an arc may be provided on the entire surface of that side of the support on which the at least one contact piece is attached.

The support, including the layer provided on it, may additionally have a metallic protective layer deposited in total by a wet-chemical process. The protective layer may be deposited by electrodeposition. The protective layer may consist of the same material as the layer. The protective layer may consist of copper. The protective layer may have a thickness of 3 μm to 10 μm. The protective layer may have a thickness of 5 μm.

The support may form a contact bridge or may be a contact spring or may be attached to a spring.

In another exemplary embodiment, a switching element for an electromechanical low voltage switch, in which the switching element is movable and has an electrically conductive support and at least one electrical contact piece attached to this support, the support consists at least in part of a metal or an alloy, the density of which lies below 5 g/cm³.

### BRIEF DESCRIPTION OF THE DRAWINGS

The accompanying drawings illustrate the invention. In such drawings:

FIG. 1 shows a longitudinal section through the switching mechanism of a low voltage switch according to the invention, which is configured as a bridge switch; and

FIG. 2 shows the view II of an end of the contact bridge of the switch shown in FIG. 1.

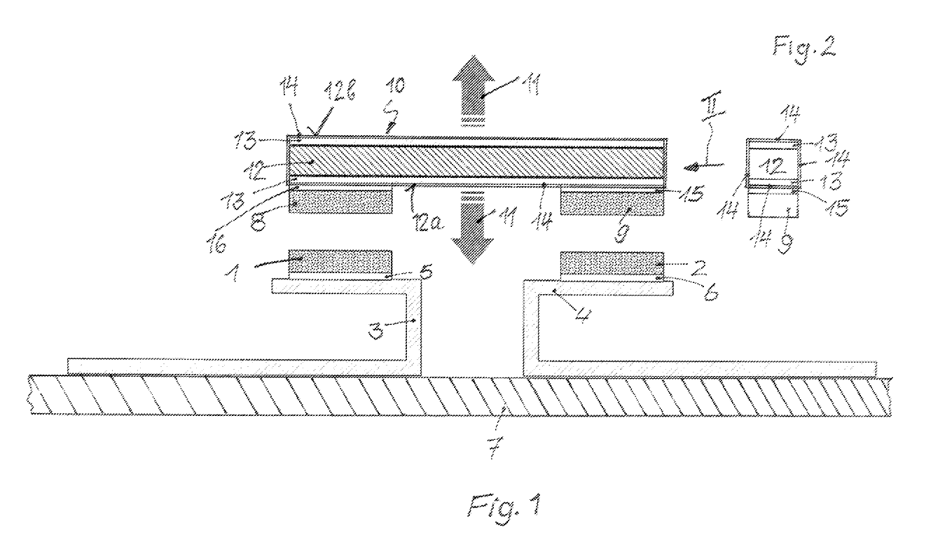

### DETAILED DESCRIPTION OF THE PREFERRED EMBODIMENTS

The low voltage switch has two fixed contacts 1 and 2, which are attached to two conductor lines 3 and 4, for example by brazing, which lines in turn are mounted on an insulating support plate 7. A brazing solder layer 5 or 6, respectively, is provided between each of the two fixed contacts 1 and 2 and the conductor lines 3 and 4, respectively.

Two movable contact pieces 8 and 9 lie opposite the two fixed contacts 1 and 2, which pieces are attached to a switching element 10 configured as a contact bridge, which switching element can be moved forward and back by means of an actuator, represented symbolically by the two arrows 11, in order to either bring the contact pieces 8 and 9 into contact with the fixed contacts 1 and 2 that lie opposite them, thereby creating a conductive connection between the two conductor lines 3 and 4, or in order to lift the contact pieces 8 and 9 off from the fixed contacts 1 and 2, thereby interrupting the conductive connection between the two conductor lines 3 and 4. The actuator can be, for example, an electromagnet having a displaceable, rod-shaped iron core, which is coupled with the contact bridge 10, with the possibility of providing a spring between the iron core and the contact bridge 10.

The contract bridge 10 has an electrically conductive support 12 composed of a light metal or of a light-metal alloy, for example of an aluminum-magnesium alloy. The support 12 is covered, on its front side 12a and on its back side 12b, over the full area, by a roll cladding process with a layer 13 composed of an electrically well conductive material, which is not ignited under the effect of an arc, particularly of copper. The thickness of the two layers 13 amounts to several tenths of a millimeter. The cladded support 12 is additionally also electrolytically provided on all sides with a protective layer 14, which consists of the same material as the layers 13 and preferably has a thickness of approximately 5 μm. Preferably, the electrolytically applied protective layer 14 consists of copper. The two movable contact pieces 8 and 9 are attached, for example by brazing, to the support 12 that has been pretreated in this manner. The brazing solder layers 15 and 16 are represented schematically. In the example shown, the protective layer 14 has been applied after roll cladding of the two layers 13, and extends also beyond the layers 13.

By selecting the material for the support 12 in accordance with the invention, its mass and, with it, the tendency to bounce has been greatly reduced, as compared to a copper support having the same dimensions.

### REFERENCE NUMBERS

1 fixed contact
2 fixed contact
3 conductor line
4 conductor line
5 brazing solder layer
6 brazing solder layer
7 support plate
8 contact piece
9 contact piece
10 contact bridge
11 arrows
12 support
12a front side of the support
12b back side of the support
13 layer
14 protective layer
15 brazing solder layer
16 brazing solder layer

What is claimed is:

1. An electromechanical low voltage switch having a movable switching element that has an electrically conductive support and at least one electrical contact piece attached to this support, wherein the support comprises a metal or an alloy, the density of which lies below 5 g/cm³.

2. The switch according to claim 1, wherein the support comprises a light metal or a light-metal alloy including aluminum, magnesium or lithium, as well as their alloys with one another.

3. The switch according to claim 1, wherein at least in a partial region that borders on the at least one contact piece the support has a layer composed of a material that does not ignite in air under the effect of an arc.

4. The switch according to claim 3, wherein the material for the layer that does not ignite under the effect of an arc comprises copper, silver, iron or an alloy of these metals.

5. The switch according to claim 3, wherein the layer has a thickness of at least 0.1 mm.

6. The switch according to claim 3, wherein the layer has a thickness of not more than 1 mm.

7. The switch according to claim 3, wherein the layer has a thickness between 0.4 mm and 0.6 mm.

8. The switch according to claim 1, wherein the support consists, with the exception of the layer preferably provided on it, in total of a light metal or of a light-metal alloy.

9. The switch according to claim 3, wherein the layer composed of the material that does not ignite under the effect of an arc is provided at least on that side of the support on which the at least one contact piece is also provided.

10. The switch according to claim 9, wherein the layer composed of the material that does not ignite under the effect of an arc is provided not only on that side of the support on which the at least one contact piece is attached, but also on the side of the support that faces away from the at least one contact piece.

11. The switch according to claim 3, wherein the layer composed of the material that does not ignite under the effect of an arc is provided on the entire surface of that side of the support on which the at least one contact piece is attached.

12. The switch according to claim 11, wherein the material that does not ignite under the effect of an arc is also provided on the entire surface of the side of the support that faces away from the at least one contact piece.

13. The switch according to claim 3, wherein the support, including the layer provided on it, additionally has a metallic protective layer deposited in total by a wet-chemical process.

14. The switch according to claim 13, wherein the protective layer consists of the same material as the layer.

15. The switch according to claim 13, wherein the protective layer has a thickness of 3 μm to 10 μm.

16. The switch according to claim 13, wherein the protective layer is deposited by electrodeposition.

17. The switch according to claim 13, wherein the protective layer consists of copper.

18. The switch according to claim 13, wherein the protective layer has a thickness of 5 μm.

19. The switch according to claim 1, wherein the support forms a contact bridge or is a contact spring or is attached to a spring.

20. A switching element for an electromechanical low voltage switch, in which the switching element is movable and has an electrically conductive support and at least one electrical contact piece attached to this support, the support consists, at least in part, of a metal or an alloy, the density of which lies below 5 g/cm³.

21. A switching element for an electromechanical low voltage switch, in which the switching element is movable and has an electrically conductive support and at least one electrical contact piece attached to this support, the support consists essentially of a metal or an alloy, the density of which lies below 5 g/cm³.
